(19) United States
(12) Patent Application Publication
(10) Pub. No.: US 2024/0397947 A1
(43) Pub. Date: Dec. 5, 2024

(54) METHOD FOR THE CONTROL OR SUPPRESSION OF PHYTOPATHOGENIC BACTERIA

(71) Applicant: SYNGENTA CROP PROTECTION AG, Basel (CH)

(72) Inventors: Thierry Manuel Claude QUEROL, Basel (CH); Steven COSKY, Greensboro, NC (US); Charles KRASNOW, Vero Beach, FL (US); Helge SIEROTZKI, Stein (CH)

(73) Assignee: SYNGENTA CROP PROTECTION AG, Basel (CH)

(21) Appl. No.: 18/262,429

(22) PCT Filed: Jan. 17, 2022
(86) PCT No.: PCT/EP2022/050896

§ 371 Date: Jul. 21, 2023

Related U.S. Application Data
(60) Provisional application No. 63/140,459, filed on Jan. 22, 2021.

(51) Int. Cl. A01N 43/56; A01P 1/00

(52) U.S. Cl. CPC A01N 43/56; A01P 1/00

(57) ABSTRACT

The present invention relates to the use of N-methoxy(phenylethyl)-pyrazole carboxamides for the control or suppression of phytopathogenic bacteria, as well as compositions comprising such compounds. In particular, it relates to the use of 3-(difluoromethyl)-N-methoxy-1-methyl-N-[1-methyl-2-(2,4,6-trichloro-phenyl)ethyl]-1H-pyrazole-4-carboxamide (pydiflumetofen) for the control or suppression phytopathogenic bacteria, as well as the use of compositions comprising such compound.

### CROSS-REFERENCE TO RELATED APPLICATIONS

This application is a U.S. National Stage Application, filed under 35 U.S.C. § 371, of International Application No. PCT/EP2022/050896, filed Jan. 17, 2022, which claims the benefit of U.S. Provisional Patent Application No. 63/140,459, filed Jan. 22, 2021, the entire contents of which are incorporated by reference herein.

The present invention relates to the use of N-methoxy(phenylethyl)-pyrazole carboxamides for the control or suppression of phytopathogenic bacteria, as well as compositions comprising such compounds. In particular, it relates to the use of 3-(difluoromethyl)-N-methoxy-1-methyl-N-[1-methyl-2-(2,4,6-trichloro-phenyl)ethyl]-1H-pyrazole-4-carboxamide (pydiflumetofen) for the control or suppression of phytopathogenic bacteria, as well as compositions comprising such compound.

Bacterial plant diseases, caused by phytopathogenic bacteria, are of key concern for growers across the world; they often cause hormonal imbalances in infected plants that may result in problems such as stunting, overgrowth, galls, root branches, defoliation, resetting, necrosis, tissue maceration, wilting, reduction in photosynthetic area, hyperplasia, and leaf epinasty. These problems alter the nutrition levels of affected plants on qualitative and quantitative levels; in addition, they negatively impact global food supplies and economics. See Kannan et al., “Sustainable Approaches to Controlling Plant Pathogenic Bacteria”.

Phytopathogenic bacteria can be easily distributed through several means, including water, wind, insects, animals, human activity, agricultural and farming equipment (especially during vegetative multiplication of a plant in nursery), and also through the soil.

The control or suppression of phytopathogenic bacteria is achieved mainly through prevention and exclusion of plant pathogens. There are currently limited solutions for controlling or suppressing the activity of phytopathogenic bacteria on plants. The main chemical controls include copper-based products (which often leave behind residues), agricultural antibiotics, and the use of resistance inducers, such as acibenzolar-S-methyl. Some fungicides used to control fungal diseases can have a suppression effect on the disease, even if they have no direct action on the phytopathogenic bacteria. For example, some strobilurins fungicides can have a tonic effect on plants and induce defense responses; however, these often require multiple applications, but have no direct action on the phytopathogenic bacteria per se.

The compound 3-(difluoromethyl)-N-methoxy-1-methyl-N-[1-methyl-2-(2,4,6-trichloro-phenyl)ethyl]-1H-pyrazole-4-carboxamide (pydiflumetofen) described in WO 2010/063700 is a broad-spectrum foliar fungicide and the first example of the new group of N-methoxy-(phenylethyl)-pyrazole-carboxamides within the succinate dehydrogenase inhibitor (SDHI) class. The present invention is based on the surprising finding that 3-(difluoromethyl)-N-methoxy-1-methyl-N-[1-methyl-2-(2,4,6-trichloro-phenyl)ethyl]-1H-pyrazole-4-carboxamide also exhibits anti-bacterial activity and suppression effects, and can thus now be employed in the fight against phytopathogenic bacteria, and therefore plant bacterial diseases.

Thus, in a first aspect the present invention relates to a method of controlling or suppressing phytopathogenic bacteria on useful plants, said method comprising applying an effective amount of 3-(difluoromethyl)-N-methoxy-1-methyl-N-[1-methyl-2-(2,4,6-trichloro-phenyl)ethyl]-1H-pyrazole-4-carboxamide, to the plant, plant part, or to the locus thereof.

In another aspect, there is provided a method of controlling or suppressing phytopathogenic bacteria on useful plants, said method comprising applying an effective amount of a composition comprising 3-(difluoromethyl)-N-methoxy-1-methyl-N-[1-methyl-2-(2,4,6-trichloro-phenyl)ethyl]-1H-pyrazole-4-carboxamide to the plant, plant part, or locus thereof.

In a further aspect, there is provided a use of 3-(difluoromethyl)-N-methoxy-1-methyl-N-[1-methyl-2-(2,4,6-trichloro-phenyl)ethyl]-1H-pyrazole-4-carboxamide, or an agrochemically acceptable salt, isomer, stereoisomer, diastereoisomer, enantiomer or tautomer thereof, to control plant bacterial diseases.

There is also provided a method of controlling or suppressing the effect of phytopathogenic bacteria on useful plants, said method comprising applying an effective amount of 3-(difluoromethyl)-N-methoxy-1-methyl-N-[1-methyl-2-(2,4,6-trichloro-phenyl)ethyl]-1H-pyrazole-4-carboxamide, to the plant, plant part, or to the locus thereof.

There is further provided a method of controlling or suppressing the effect of phytopathogenic bacteria on useful plants, said method comprising applying an effective amount of a composition comprising 3-(difluoromethyl)-N-methoxy-1-methyl-N-[1-methyl-2-(2,4,6-trichloro-phenyl)ethyl]-1H-pyrazole-4-carboxamide to the plant, plant part, or locus thereof.

3-(Difluoromethyl)-N-methoxy-1-methyl-N-[1-methyl-2-(2,4,6-trichloro-phenyl)ethyl]-1H-pyrazole-4-carboxamide and its preparation are described in WO 2010/063700, WO 2013/127764, and WO 2014/206855. The skilled person will appreciate that 3-(difluoromethyl)-N-methoxy-1-methyl-N-[1-methyl-2-(2,4,6-trichloro-phenyl)ethyl]-1H-pyrazole-4-carboxamide exists in two enantiomeric forms: 3-(difluoromethyl)-N-methoxy-1-methyl-N-[(1R)-1-methyl-2-(2,4,6-trichloro-phenyl)ethyl]-1H-pyrazole-4-carboxamide and 3-(difluoromethyl)-N-methoxy-1-methyl-N-[(1S)-1-methyl-2-(2,4,6-trichloro-phenyl)ethyl]-1H-pyrazole-4-carboxamide. Both enantiomers can be used for the control or suppression of phytopathogenic bacteria, individually, or as a racemate. The compound 3-(difluoromethyl)-N-methoxy-1-methyl-N-[1-methyl-2-(2,4,6-trichloro-phenyl)ethyl]-1H-pyrazole-4-carboxamide may be referred to herein by full name, ISO name, or as “the compound”.

As described herein, the present invention relates to methods for controlling or suppressing phytopathogenic bacteria on useful plants, comprising the application of 3-(difluoromethyl)-N-methoxy-1-methyl-N-[1-methyl-2-(2,4,6-trichloro-phenyl)ethyl]-1H-pyrazole-4-carboxamide to the useful plant to be protected, or its locus, in an effective amount to act on the phytopathogenic bacteria. 3-(Difluoromethyl)-N-methoxy-1-methyl-N-[1-methyl-2-(2,4,6-trichloro-phenyl)ethyl]-1H-pyrazole-4-carboxamide may also be applied to plant propagation material, such as seeds, cuttings, and young plants.

There is also described a method for controlling or suppressing the effect of phytopathogenic bacteria on useful plants, comprising the application of 3-(difluoromethyl)-N-methoxy-1-methyl-N-[1-methyl-2-(2,4,6-trichloro-phenyl)ethyl]-1H-pyrazole-4-carboxamide to the useful plant to be protected, or its locus, in an effective amount to act on the phytopathogenic bacteria.

As used herein the term “useful plants” typically includes plants of the following species: grape vines; cereals, such as wheat, barley, rye, or oats; beet, such as sugar beet or fodder beet; fruits, such as pomes, stone fruits or soft fruits, for example apples, pears, plums, peaches, almonds, walnuts, cherries, strawberries, raspberries, or blackberries; leguminous plants, such as beans, lentils, peas, or soybeans; oil plants, such as rape, mustard, poppy, olives, sunflowers, coconut, castor oil plants, cocoa beans, or groundnuts; cucumber plants, such as marrows, cucumbers, or melons; fibre plants, such as cotton, flax, hemp, or jute; citrus fruit, such as oranges, lemons, grapefruit, or mandarins; vegetables, such as brassicas, spinach, lettuce, asparagus, cabbages, carrots, onions, tomatoes, potatoes, sweet potatoes, cucurbits, peppers, paprika, or herbs; lauraceae, such as avocados, cinnamon, or camphor; rice; maize; tobacco; nuts; coffee; sugar cane; tea; vines; hops; durian; bananas; natural rubber plants; turf or ornamentals, such as flowers, shrubs, broad-leaved trees, or evergreens, for example conifers; ornamental crops, for example roses, geranium, pelargonium, impatiens, cyclamen, poinsettia, pansies, magnolia, or zinnia; flower bulbs, for example tulips. This above list does not represent any limitation.

As used herein the term “phytopathogenic bacteria” refers to bacteria that cause disease in plants. Examples of phytopathogenic bacteria include, but are not limited to, Agrobacterium spp., Acidovorax spp., Arthrobacter spp., Burkholderia spp., Candidatus liberibacter spp., Clavibacter spp., Clostridium spp., Corynebacterium spp., Dickeya spp., Erwinia spp., Leifsonia spp., Pantoea spp., Pectobacteriumm spp., Phytoplasma spp., Pseudomonas spp., Ralstonia spp., Rhizobacter spp., Rhizomonas spp., Rhodococcus spp., Serratia spp., Sphingomonas spp., Sprioplasma spp., Streptomyces spp., Xanthomonas spp., and Xylella spp.

The term “locus” as used herein means fields in or on which plants are growing, or where seeds of cultivated plants are sown, or where seed will be placed into the soil. It includes soil, seeds, and seedlings, as well as established vegetation.

The term “plants” refers to all physical parts of a plant, including seeds, seedlings, roots, stems, stalks and foliage.

The term “plant propagation material” as used herein is understood to denote generative parts of a useful plant, such as seeds, which can be used for the multiplication of the latter, and vegetative material, such as cuttings or tubers, for example potatoes. There may be mentioned for example seeds (in the strict sense), roots, fruits, tubers, bulbs, corms, rhizomes, and parts of plants.

Germinated plants and young plants which are to be transplanted after germination or after emergence from the soil, may also be mentioned. These young plants may be protected before transplantation by a total or partial treatment by immersion in the compound. Preferably “plant propagation material” is understood to denote seeds and/or roots, more preferably seeds.

The term “bactericide” as used herein with respect to 3-(difluoromethyl)-N-methoxy-1-methyl-N-[1-methyl-2-(2,4,6-trichloro-phenyl)ethyl]-1H-pyrazole-4-carboxamide means that the compound is capable of controlling or suppressing phytopathogenic bacteria.

In order to control or suppress phytopathogenic bacteria, 3-(difluoromethyl)-N-methoxy-1-methyl-N-[1-methyl-2-(2,4,6-trichloro-phenyl)ethyl]-1H-pyrazole-4-carboxamide, is applied or administered in an “effective amount”, by which is meant any amount of 3-(difluoromethyl)-N-methoxy-1-methyl-N-[1-methyl-2-(2,4,6-trichloro-phenyl)ethyl]-1H-pyrazole-4-carboxamide that, upon suitable application, is sufficient to achieve the desired level of phytopathogenic bacterial control or suppression.

The efficacy of 3-(difluoromethyl)-N-methoxy-1-methyl-N-[1-methyl-2-(2,4,6-trichloro-phenyl)ethyl]-1H-pyrazole-4-carboxamide against phytopathogenic bacteria may be assessed by comparing for example, in the case of Xanthomonas spp., the area of injured leaf. The skilled person is familiar with such methods, and further details for various methods are given below, in the Examples.

The phrase “controlling or suppressing the effect of phytopathogenic bacteria” as used herein with respect to 3-(difluoromethyl)-N-methoxy-1-methyl-N-[1-methyl-2-(2,4,6-trichloro-phenyl)ethyl]-1H-pyrazole-4-carboxamide means that the compound is capable of decreasing the incidence or severity of the effect phytopathogenic bacteria have on crops of useful plants. For example, in the case of Xanthomonas spp., preventing or decreasing leaf spot; and in the case of Agrobacterium. spp., preventing galls (i.e. preventing the formation of tumours). This list does not represent any limitation.

The compound 3-(difluoromethyl)-N-methoxy-1-methyl-N-[1-methyl-2-(2,4,6-trichloro-phenyl)ethyl]-1H-pyrazole-4-carboxamide may be used to keep a plant healthy and may be used curatively, preventively, or systematically to control or suppress phytopathogenic bacteria. The control or suppression of phytopathogenic bacteria reduces damage to plants and thus may result in a concomitant increase in yield.

Examples of phytopathogenic bacteria to which 3-(difluoromethyl)-N-methoxy-1-methyl-N-[1-methyl-2-(2,4,6-trichloro-phenyl)ethyl]-1H-pyrazole-4-carboxamide is applicable include Agrobacterium spp., Acidovorax spp., Arthrobacter spp., Burkholderia spp., Candidatus liberibacter spp., Clavibacter spp., Clostridium spp., Corynebacterium spp., Dickeya spp., Erwinia spp., Leifsonia spp., Pantoea spp., Pectobacterium spp., Phytoplasma spp., Pseudomonas spp., Ralstonia spp., Rhizobacter spp., Rhizomonas spp., Rhodococcus spp., Serratia spp., Sphingomonas spp., Sprioplasma spp., Streptomyces spp., Xanthomonas spp., and Xylella spp.

In particular, examples of phytopathogenic bacteria to which 3-(difluoromethyl)-N-methoxy-1-methyl-N-[1-methyl-2-(2,4,6-trichloro-phenyl)ethyl]-1H-pyrazole-4-carboxamide is applicable include Agrobacterium spp., Candidatus liberibacter spp., Clavibacter spp., Dickeya spp., Erwinia spp., Pectobacterium spp., Pseudomonas spp., Rastonia spp., and Xanthomonas spp.

Preferably, phytopathogenic bacteria to which 3-(difluoromethyl)-N-methoxy-1-methyl-N-[1-methyl-2-(2,4,6-trichloro-phenyl)ethyl]-1H-pyrazole-4-carboxamide is applicable include Agrobacterium tumefaciens, Candidatus liberibacter asiaticus, Clavibacter michiganensis, Clavibacter sepedonicus, Dickeya dadantil, Dickeya solani, Erwinia amylovora, Pectobacterium atrospeticum, Pectobacterium carotovorum, Pseudonomas savastoni, Pseudomonas synngae, Ralstonia solanacearum, Xanthomonas axonopodis, Xanthomonas campestris, Xanthomonas oryzae, Xanthomonas peribrans, and Xylella fastidiosa.

More preferably, phytopathogenic bacteria to which 3-(difluoromethyl)-N-methoxy-1-methyl-N-[1-methyl-2-(2,4,6-trichloro-phenyl)ethyl]-1H-pyrazole-4-carboxamide is applicable include Agrobacterium tumefaciens, Dickeya dadantil, Dickeya solani, Erwinia amylovora, Pectobacterium atrospeticum, Pectobacterium carotovorum, Pseudomonas synngae, Ralstonia solanacearum, Xanthomonas axonopodis, Xanthomonas campestris, Xanthomonas oryzae, Xanthomonas perforans, and Xylella fastidiosa.

In one embodiment, there is provided a method of controlling or suppressing phytopathogenic bacteria selected from Xanthomonas spp, Pseudomonas spp, Agrobacterium spp, Ralstonia spp, Clavibacter spp, and Xylella spp. There is provided a method of controlling or suppressing the effect of phytopathogenic bacteria on useful plants, wherein the phytopathogenic bacteria is selected from Xanthomonas spp, Pseudomonas spp, Agrobacterium spp, Ralstonia spp, Clavibacter spp, and Xylella spp.

In another embodiment, there is provided a method of controlling or suppressing phytopathogenic bacteria selected from Agrobacterium spp., Pseudomonas spp., Ralstonia spp., and Xanthomonas spp. There is provided a method of controlling or suppressing the effect of phytopathogenic bacteria on useful plants, wherein the phytopathogenic bacteria is selected from Agrobacterium spp., Pseudomonas spp., Ralstonia spp., and Xanthomonas spp.

As shown herein, 3-(difluoromethyl)-N-methoxy-1-methyl-N-[1-methyl-2-(2,4,6-trichloro-phenyl)ethyl]-1H-pyrazole-4-carboxamide is particularly efficacious against Agrobacterium spp., Pseudomonas syringae, Ralstonia spp., and Xanthomonas spp. In particular, 3-(difluoromethyl)-N-methoxy-1-methyl-N-[1-methyl-2-(2,4,6-trichloro-phenyl)ethyl]-1H-pyrazole-4-carboxamide is particularly efficacious against Agrobacterium tumefaciens, Pseudomonas syringae, Xanthomonas perforans, Xanthomonas orycea, and Xanthomonas perfbrans, and Xanthomonas campestris.

Useful plants upon which 3-(difluoromethyl)-N-methoxy-1-methyl-N-[1-methyl-2-(2,4,6-trichloro-phenyl)ethyl]-1H-pyrazole-4-carboxamide may be used include grape vines; cereals, such as wheat, barley, rye or oats; beet, such as sugar beet or fodder beet; fruits, such as pomes, stone fruits or soft fruits, for example apples, pears, plums, peaches, almonds, cherries, strawberries, raspberries or blackberries; leguminous plants, such as beans, lentils, peas or soybeans; oil plants, such as rape, mustard, poppy, olives, sunflowers, coconut, castor oil plants, cocoa beans or groundnuts; cucumber plants, such as marrows, cucumbers or melons; fibre plants, such as cotton, flax, hemp or jute; citrus fruit, such as oranges, lemons, grapefruit or mandarins; vegetables, such as brassicas, spinach, lettuce, asparagus, cabbages, carrots, onions, tomatoes, potatoes, sweet potatoes, cucurbits, peppers, paprika, or herbs; lauraceae, such as avocados, cinnamon, or camphor; rice; maize; tobacco; nuts; coffee; sugar cane; tea; vines; hops; durian; bananas; natural rubber plants; turf or ornamentals, such as flowers, shrubs, broad-leaved trees or evergreens, for example conifers; ornamental crops, for example roses, geranium, pelargonium, impatiens, cyclamen, poinsettia, pansies, magnolia, zinnia; flower bulbs, for example tulips.

Preferred useful plants upon which 3-(difluoromethyl)-N-methoxy-1-methyl-N-[1-methyl-2-(2,4,6-trichloro-phenyl)ethyl]-1H-pyrazole-4-carboxamide may be used include vegetables, fruits, grape vines, rice, and ornamentals. More preferred useful plants include tomato, geranium, pelargonium, magnolia, rice, and zinnia.

The compound 3-(difluoromethyl)-N-methoxy-1-methyl-N-[1-methyl-2-(2,4,6-trichloro-phenyl)ethyl]-1H-pyrazole-4-carboxamide for the control of phytopathogenic bacteria can be used in unmodified form or, preferably, together with carriers and adjuvants conventionally employed in the art of formulation, and as described previously, for example, in WO 2010/063700. Typically, when used for fungal control, 3-(difluoromethyl)-N-methoxy-1-methyl-N-[1-methyl-2-(2,4,6-trichloro-phenyl)ethyl]-1H-pyrazole-4-carboxamide is applied to useful plants via foliar application. However, in order to control phytopathogenic bacteria, the preferred application methods are directly to the plant, the locus of the plant (e.g. the soil) or directly to plant propagation material (e.g. applied to the seed).

In a further embodiment, 3-(difluoromethyl)-N-methoxy-1-methyl-N-[1-methyl-2-(2,4,6-trichloro-phenyl)ethyl]-1H-pyrazole-4-carboxamide is applied to the plant, plant part, or locus thereof in the form of a bactericidal formulation. This formulation may contain one or more other desirable components including but not limited to liquid diluents, binders to serve as a matrix for the compounds as described herein, fillers for protecting the seeds, and plasticizers to improve flexibility, adhesion and/or spreadability of the coating.

The bactericidal formulation e.g. a composition containing 3-(difluoromethyl)-N-methoxy-1-methyl-N-[1-methyl-2-(2,4,6-trichloro-phenyl)ethyl]-1H-pyrazole-4-carboxamide, and, if desired, a solid or liquid adjuvant or monomers for encapsulating the compound, may be prepared in a known manner, typically by mixing and/or grinding the compound with extenders, for example solvents, solid carriers and, optionally, surface active compounds (surfactants).

Typical rates of application per hectare is generally 1 g to 2000 g of 3-(difluoromethyl)-N-methoxy-1-methyl-N-[1-methyl-2-(2,4,6-trichloro-phenyl)ethyl]-1H-pyrazole-4-carboxamide per hectare, in particular 10 g to 1000 g/ha, preferably 10 to 800 g/ha, more preferably 20 g to 600 g/ha, and most preferably 40 g to 500 g/ha. In particular, 3-(difluoromethyl)-N-methoxy-1-methyl-N-[1-methyl-2-(2,4,6-trichloro-phenyl)ethyl]-1H-pyrazole-4-carboxamide is applied at 40 g to 400 g of active ingredient per hectare. When used for treating seeds or as a drenching agent, convenient rates of application are from 1 mg to 50 g of active substance per kg of seeds, preferably from 10 mg to 30 g of active substance per kg of seeds, and more preferably, from 10 mg to 1 g of active substance per kg of seeds.

The compositions of the invention may be employed in any conventional form, for example in the form of a twin pack, a powder for dry seed treatment (DS), an emulsion for seed treatment (ES), a flowable concentrate for seed treatment (FS), a solution for seed treatment (LS), a water dispersible powder for seed treatment (WS), a capsule suspension for seed treatment (CF), a gel for seed treatment (GF), an emulsion concentrate (EC), a suspension concentrate (SC), a suspo-emulsion (SE), a capsule suspension (CS), a water dispersible granule (WG), an emulsifiable granule (EG), an emulsion, water in oil (EO), an emulsion, oil in water (EW), a micro-emulsion (ME), an oil dispersion (OD), an oil miscible flowable (OF), an oil miscible liquid (OL), a soluble concentrate (SL), an ultra-low volume suspension (SU), an ultra-low volume liquid (UL), a technical concentrate (TK), a dispersible concentrate (DC), a wettable powder (WP) or any technically feasible formulation in combination with agriculturally acceptable adjuvants.

Such compositions may be produced in conventional manner, e.g., by mixing the active ingredients with appropriate formulation inerts (diluents, solvents, fillers and optionally other formulating ingredients such as surfactants, biocides, anti-freeze, stickers, thickeners and compounds that provide adjuvancy effects). Also conventional slow release formulations may be employed where long lasting efficacy is intended. Particularly formulations to be applied in spraying forms, such as water dispersible concentrates (e.g. EC, SC, DC, OD, SE, EW, EO and the like), wettable powders and granules, may contain surfactants such as wetting and dispersing agents and other compounds that provide adjuvancy effects, e.g. the condensation product of formaldehyde with naphthalene sulphonate, an alkylarylsulphonate, a lignin sulphonate, a fatty alkyl sulphate, and ethoxylated alkylphenol and an ethoxylated fatty alcohol.

In general, the formulations include from 0.01 to 90% by weight of active agent, from 0 to 20% agriculturally acceptable surfactant and 10 to 99.99% solid or liquid formulation inerts and adjuvant(s), the active agent consisting of at least containing 3-(difluoromethyl)-N-methoxy-1-methyl-N-[1-methyl-2-(2,4,6-trichloro-phenyl)ethyl]-1H-pyrazole-4-carboxamide together with component (B) and (C), and optionally other active agents, particularly microbiocides or conservatives or the like. Concentrated forms of compositions generally contain in between about 2 and 80%, preferably between about 5 and 70% by weight of active agent. Application forms of formulation may for example contain from 0.01 to 20% by weight, preferably from 0.01 to 5% by weight of active agent. Whereas commercial products will preferably be formulated as concentrates, the end user will normally employ diluted formulations.

3-(Difluoromethyl)-N-methoxy-1-methyl-N-[1-methyl-2-(2,4,6-trichloro-phenyl)ethyl]-1H-pyrazole-4-carboxamide may be the sole active ingredient of a composition or it may be admixed with one or more additional active ingredients such as a pesticide, fungicide, synergist, herbicide or plant growth regulator where appropriate. An additional active ingredient may, in some cases, result in unexpected synergistic activities.

Examples of suitable additional active ingredients include a compound selected from the group of substances consisting of petroleum oils, 1,1-bis(4-chlorophenyl)-2-ethoxyethanol, 2,4-dichlorophenyl benzenesulfonate, 2-fluoro-N-methyl-N-1-naphthylacetamide, 4-chlorophenyl phenyl sulfone, acetoprole, aldoxycarb, amidithion, amidothioate, amiton, amiton hydrogen oxalate, amitraz, aramite, arsenous oxide, azobenzene, azothoate, benomyl, benoxafos, benzyl benzoate, bixafen, brofenvalerate, bromocyclen, bromophos, bromopropylate, buprofezin, butocarboxim, butoxycarboxim, butylpyridaben, calcium polysulfide, camphechlor, carbanolate, carbophenothion, cymiazole, chinomethionat, chlorbenside, chlordimeform, chlordimeform hydrochloride, chlorfenethol, chlorfenson, chlorfensulfide, chlorobenzilate, chloromebuform, chloromethiuron, chloropropylate, chlorthiophos, cinerin I, cinerin II, cinerins, closantel, coumaphos, crotamiton, crotoxyphos, cufraneb, cyanthoate, DCPM, DDT, demephion, demephion-O, demephion-S, demeton-methyl, demeton-O, demeton-O-methyl, demeton-S, demeton-S-methyl, demeton-S-methylsulfon, dichlofluanid, dichlorvos, dicliphos, dienochlor, dimefox, dinex, dinex-diclexine, dinocap-4, dinocap-6, dinocton, dinopenton, dinosulfon, dinoterbon, dioxathion, diphenyl sulfone, disulfiram, DNOC, dofenapyn, doramectin, endothion, eprinomectin, ethoate-methyl, etrimfos, fenazaflor, fenbutatin oxide, fenothiocarb, fenpyrad, fenpyroximate, fenpyrazamine, fenson, fentrifanil, flubenzimine, flucycloxuron, fluenetil, fluorbenside, FMC 1137, formetanate, formetanate hydrochloride, formparanate, gamma-HCH, glyodin, halfenprox, hexadecyl cyclopropanecarboxylate, isocarbophos, jasmolin I, jasmolin II, jodfenphos, lindane, malonoben, mecarbam, mephosfolan, mesulfen, methacrifos, methyl bromide, metokcarb, mexacarbate, milbemycin oxime, mipafox, monocrotophos, morphothion, moxidectin, naled, 4-chloro-2-(2-chloro-2-methyl-propyl)-5-[(6-iodo-3-pyridyl)methoxy]pyridazin-3-one, nifluridide, nikkomycins, nitrilacarb, nitrilacarb 1:1 zinc chloride complex, omethoate, oxydeprofos, oxydisulfoton, pp′-DDT, parathion, permethrin, phenkapton, phosalone, phosfolan, phosphamidon, polychloroterpenes, polynactins, proclonol, promacyl, propoxur, prothidathion, prothoate, pyrethrin I, pyrethrin II, pyrethrins, pyridaphenthion, pyrimitate, quinalphos, quintiofos, R-1492, phosglycin, rotenone, schradan, sebufos, selamectin, sophamide, SSI-121, sulfiram, sulfluramid, sulfotep, sulfur, diflovidazin, tau-fluvalinate, TEPP, terbam, tetradifon, tetrasul, thiafenox, thiocarboxime, thiofanox, thiometon, thioquinox, thuringiensin, triamiphos, triarathene, triazophos, triazuron, trifenofos, trinactin, vamidothion, vaniliprole, bethoxazin, copper dioctanoate, copper sulfate, cybutryne, dichlone, dichlorophen, endothal, fentin, hydrated lime, nabam, quinoclamine, quinonamid, simazine, triphenyltin acetate, triphenyltin hydroxide, crufomate, piperazine, thiophanate, chloralose, fenthion, pyridin-4-amine, strychnine, 1-hydroxy-1H-pyridine-2-thione, 4-(quinoxalin-2-ylamino)benzenesulfonamide, 8-hydroxyquinoline sulfate, bronopol, copper hydroxide, cresol, dipyrithione, dodicin, fenaminosulf, formaldehyde, hydrargaphen, kasugamycin, kasugamycin hydrochloride hydrate, nickel bis(dimethyldithiocarbamate), nitrapyrin, octhilinone, oxolinic acid, oxytetracycline, potassium hydroxyquinoline sulfate, probenazole, streptomycin, streptomycin sesquisulfate, tecloftalam, thiomersal, Adoxophyes orana GV, Agrobacterium radiobacter, Amblyseius spp., Anagrapha falcifera NPV, Anagrus atomus, Aphelinus abdominalis, Aphidius colemani, Aphidoletes aphidimyza, Autographa californica NPV, Bacillus sphaericus Neide, Beauveria brongniartii, Chrysoperla carnea, Cryptolaemus montrouzieri, Cydia pomonella GV, Dacnusa sibirica, Diglyphus isaea, Encarsia formosa, Eretmocerus eremicus, Heterorhabditis bacteriophora and H. megidis, Hippodamia convergens, Leptomastix dactylopii, Macrolophus caliginosus, Mamestra brassicae NPV, Metaphycus helvolus, Metarhizium anisopliae var. acridum, Metarhizium anisopliae var. anisopliae, Neodiprion sertifer NPV and N. lecontei NPV, Orius spp., Paecilomyces fumosoroseus, Phytoseiulus persimilis, Steinemema bibionis, Steinemema carpocapsae, Steinemema feltiae, Steinemema glaseri, Steinemema riobrave, Steinemema riobravis, Steinemema scapterisci, Steinemema spp., Trichogramma spp., Typhlodromus occidentalis, Verticillium lecanii, apholate, bisazir, busulfan, dimatif, hemel, hempa, metepa, methiotepa, methyl apholate, morzid, penfluron, tepa, thiohempa, thiotepa, tretamine, uredepa, (E)-dec-5-en-1-yl acetate with (E)-dec-5-en-1-ol, (E)-tridec-4-en-1-yl acetate, (E)-6-methylhept-2-en-4-ol, (E,Z)-tetradeca-4,10-dien-1-yl acetate, (Z)-dodec-7-en-1-yl acetate, (Z)-hexadec-11-enal, (Z)-hexadec-11-en-1-yl acetate, (Z)-hexadec-13-en-11-yn-1-yl acetate, (Z)-icos-13-en-10-one, (Z)-tetradec-7-en-1-al, (Z)-tetradec-9-en-1-ol, (Z)-tetradec-9-en-1-yl acetate, (7E,9Z)-dodeca-7,9-dien-1-yl acetate, (9Z,11E)-tetradeca-9,11-dien-1-yl acetate, (9Z,12E)-tetradeca-9,12-dien-1-yl acetate, 14-methyloctadec-1-ene, 4-methylnonan-5-ol with 4-methylnonan-5-one, alpha-multistriatin, brevicomin, codlelure, codlemone, cuelure, disparlure, dodec-8-en-1-yl acetate, dodec-9-en-1-yl acetate, dodeca-8, 10-dien-1-yl acetate, dominicalure, ethyl 4-methyloctanoate, eugenol, frontalin, grandlure, grandlure I, grandlure II, grandlure III, grandlure IV, hexalure, ipsdienol, ipsenol, japonilure, lineatin, litlure, looplure, medlure, megatomoic acid, methyl eugenol, muscalure, octadeca-2,13-dien-1-yl acetate, octadeca-3,13-dien-1-yl acetate, orfralure, oryctalure, ostramone, siglure, sordidin, sulcatol, tetradec-11-en-1-yl acetate, trimedlure, trimedlure A, trimedlure B₁, trimedlure B₂, trimedlure C, trunc-call, 2-(octylthio)ethanol, butopyronoxyl, butoxy(polypropylene glycol), dibutyl adipate, dibutyl phthalate, dibutyl succinate, diethyltoluamide, dimethyl carbate, dimethyl phthalate, ethyl hexanediol, hexamide, methoquin-butyl, methylneodecanamide, oxamate, picaridin, 1-dichloro-1-nitroethane, 1,1-dichloro-2,2-bis(4-ethylphenyl)ethane, 1,2-dichloropropane with 1,3-dichloropropene, 1-bromo-2-chloroethane, 2,2,2-trichloro-1-(3,4-dichlorophenyl)ethyl acetate, 2,2-dichlorovinyl 2-ethylsulfinylethyl methyl phosphate, 2-(1,3-dithiolan-2-yl)phenyl dimethylcarbamate, 2-(2-butoxyethoxy)ethyl thiocyanate, 2-(4,5-dimethyl-1,3-dioxolan-2-yl)phenyl methylcarbamate, 2-(4-chloro-3,5-xylyloxy)ethanol, 2-chlorovinyl diethyl phosphate, 2-imidazolidone, 2-isovalerylindan-1,3-dione, 2-methyl(prop-2-ynyl)aminophenyl methylcarbamate, 2-thiocyanatoethyl laurate, 3-bromo-1-chloroprop-1-ene, 3-methyl-1-phenylpyrazol-5-yl dimethylcarbamate, 4-methyl(prop-2-ynyl)amino-3,5-xylyl methylcarbamate, 5,5-dimethyl-3-oxocyclohex-1-enyl dimethylcarbamate, acethion, acrylonitrile, aldrin, allosamidin, allyxycarb, alpha-ecdysone, aluminium phosphide, aminocarb, anabasine, athidathion, azamethiphos, Bacillus thuringiensis delta endotoxins, barium hexafluorosilicate, barium polysulfide, barthrin, Bayer 22/190, Bayer 22408, beta-cyfluthrin, beta-cypermethrin, bioethanomethrin, biopermethrin, bis(2-chloroethyl) ether, borax, bromfenvinfos, bromo-DDT, bufencarb, butacarb, butathiofos, butonate, calcium arsenate, calcium cyanide, carbon disulfide, carbon tetrachloride, cartap hydrochloride, cevadine, chlorbicyclen, chlordane, chlordecone, chloroform, chloropicrin, chlorphoxim, chlorprazophos, cis-resmethrin, cismethrin, clocythrin, copper acetoarsenite, copper arsenate, copper oleate, coumithoate, cryolite, CS 708, cyanofenphos, cyanophos, cyclethrin, cythioate, d-tetramethrin, DAEP, dazomet, decarbofuran, diamidafos, dicapthon, dichlofenthion, dicresyl, dicyclanil, dieldrin, diethyl 5-methylpyrazol-3-yl phosphate, dilor, dimefluthrin, dimetan, dimethrin, dimethylvinphos, dimetilan, dinoprop, dinosam, dinoseb, diofenolan, dioxabenzofos, dithicrofos, DSP, ecdysterone, EI 1642, EMPC, EPBP, etaphos, ethiofencarb, ethyl formate, ethylene dibromide, ethylene dichloride, ethylene oxide, EXD, fenchlorphos, fenethacarb, fenitrothion, fenoxacrim, fenpirithrin, fensulfothion, fenthion-ethyl, flucofuron, fosmethilan, fospirate, fosthietan, furathiocarb, furethrin, guazatine, guazatine acetates, sodium tetrathiocarbonate, halfenprox, HCH, HEOD, heptachlor, heterophos, HHDN, hydrogen cyanide, hyquincarb, IPSP, isazofos, isobenzan, isodrin, isofenphos, isolane, isoprothiolane, isoxathion, juvenile hormone I, juvenile hormone II, juvenile hormone III, kelevan, kinoprene, lead arsenate, leptophos, lirimfos, lythidathion, m-cumenyl methylcarbamate, magnesium phosphide, mazidox, mecarphon, menazon, mercurous chloride, mesulfenfos, metam, metam-potassium, metam-sodium, methanesulfonyl fluoride, methocrotophos, methoprene, methothrin, methoxychlor, methyl isothiocyanate, methylchloroform, methylene chloride, metoxadiazone, mirex, naftalofos, naphthalene, NC-170, nicotine, nicotine sulfate, nithiazine, nornicotine, O-5-dichloro-4-iodophenyl O-ethyl ethylphosphonothioate, O,O-diethyl O-4-methyl-2-oxo-2H-chromen-7-yl phosphorothioate, O,O-diethyl O-6-methyl-2-propylpyrimidin-4-yl phosphorothioate, O,O,O′,O′-tetrapropyl dithiopyrophosphate, oleic acid, para-dichlorobenzene, parathion-methyl, pentachlorophenol, pentachlorophenyl laurate, PH 60-38, phenkapton, phosnichlor, phosphine, phoxim-methyl, pirimetaphos, polychlorodicyclopentadiene isomers, potassium arsenite, potassium thiocyanate, precocene I, precocene II, precocene III, primidophos, profluthrin, promecarb, prothiofos, pyrazophos, pyresmethrin, quassia, quinalphos-methyl, quinothion, rafoxanide, resmethrin, rotenone, kadethrin, ryania, ryanodine, sabadilla, schradan, sebufos, SI-0009, thiapronil, sodium arsenite, sodium cyanide, sodium fluoride, sodium hexafluorosilicate, sodium pentachlorophenoxide, sodium selenate, sodium thiocyanate, sulcofuron, sulcofuron-sodium, sulfuryl fluoride, sulprofos, tar oils, tazimcarb, TDE, tebupirimfos, temephos, terallethrin, tetrachloroethane, thicrofos, thiocyclam, thiocyclam hydrogen oxalate, thionazin, thiosultap, thiosultap-sodium, tralomethrin, transpermethrin, triazamate, trichlormetaphos-3, trichloronat, trimethacarb, tolprocarb, triclopyricarb, triprene, veratridine, veratrine, XMC, zetamethrin, zinc phosphide, zolaprofos, meperfluthrin, tetramethylfluthrin, bis(tributyltin) oxide, bromoacetamide, ferric phosphate, niclosamide-olamine, tributyltin oxide, pyrimorph, trifenmorph, 1,2-dibromo-3-chloropropane, 1,3-dichloropropene, 3,4-dichlorotetrahydrothiophene 1,1-dioxide, 3-(4-chlorophenyl)-5-methylrhodanine, 5-methyl-6-thioxo-1,3,5-thiadiazinan-3-ylacetic acid, 6-isopentenylaminopurine, anisiflupurin, benclothiaz, cytokinins, DCIP, furfural, isamidofos, kinetin, Myrothecium verrucaria composition, tetrachlorothiophene, xylenols, zeatin, potassium ethylxanthate, acibenzolar, acibenzolar-S-methyl, Reynoutria sachalinensis extract, alpha-chlorohydrin, antu, barium carbonate, bisthiosemi, brodifacoum, bromadiolone, bromethalin, chlorophacinone, cholecalciferol, coumachlor, coumafuryl, coumatetralyl, crimidine, difenacoum, difethialone, diphacinone, ergocalciferol, flocoumafen, fluoroacetamide, flupropadine, flupropadine hydrochloride, norbormide, phosacetim, phosphorus, pindone, pyrinuron, scilliroside, sodium fluoroacetate, thallium sulfate, warfarin, 2-(2-butoxyethoxy)-ethyl piperonylate, 5-(1,3-benzodioxol-5-yl)-3-hexylcyclohex-2-enone, farnesol with nerolidol, verbutin, MGK 264, piperonyl butoxide, piprotal, propyl isomer, S421, sesamex, sesasmolin, sulfoxide, anthraquinone, copper naphthenate, copper oxychloride, dicyclopentadiene, thiram, zinc naphthenate, ziram, imanin, ribavirin, chloroinconazide, mercuric oxide, thiophanate-methyl, azaconazole, bitertanol, bromuconazole, cyproconazole, difenoconazole, diniconazole, epoxiconazole, fenbuconazole, fluquinconazole, flusilazole, flutriafol, furametpyr, hexaconazole, imazalil, imibenconazole, ipconazole, metconazole, myclobutanil, paclobutrazole, pefurazoate, penconazole, prothioconazole, pyrifenox, prochloraz, propiconazole, pyrisoxazole, simeconazole, tebuconazole, tetraconazole, triadimefon, triadimenol, triflumizole, triticonazole, ancymidol, fenarimol, nuarimol, bupirimate, dimethirimol, ethirimol, dodemorph, fenpropidin, fenpropimorph, spiroxamine, tridemorph, cyprodinil, mepanipyrim, pyrimethanil, fenpiclonil, fludioxonil, benalaxyl, furalaxyl, metalaxyl, R-metalaxyl, ofurace, oxadixyl, carbendazim, debacarb, fuberidazole, thiabendazole, chlozolinate, dichlozoline, myclozoline, procymi-done, vinclozoline, boscalid, carboxin, fenfuram, flutolanil, mepronil, oxycarboxin, penthiopyrad, thifluzamide, dodine, iminoctadine, azoxystrobin, dimoxystrobin, enestroburin, fenaminstrobin, flufenoxystrobin, fluoxastrobin, kresoxim-methyl, metominostrobin, trifloxystrobin, orysastrobin, picoxystrobin, pyraciostrobin, pyrametostrobin, pyraoxystrobin, ferbam, mancozeb, maneb, metiram, propineb, zineb, captafol, captan, fluoroimide, folpet, tolylfluanid, bordeaux mixture, copper oxide, mancopper, oxine-copper, nitrothal-isopropyl, edifenphos, iprobenphos, phosdiphen, tolclofos-methyl, anilazine, benthiavalicarb, blasticidin-S, chloroneb, chlorothalonil, cyflufenamid, cymoxanil, cyclobutrifluram, diclocymet, diclomezine, dicloran, diethofencarb, dimethomorph, flumorph, dithianon, ethaboxam, etridiazole, famoxadone, fenamidone, fenoxanil, ferimzone, fluazinam, flumetylsulforim, fluopicolide, fluoxytioconazole, flusulfamide, fluxapyroxad, fenhexamid, fosetyl-aluminium, hymexazol, iprovalicarb, cyazofamid, methasulfocarb, metrafenone, pencycuron, phthalide, polyoxins, propamocarb, pyribencarb, proquinazid, pyroquilon, pyriofenone, quinoxyfen, quintozene, tiadinil, triazoxide, tricyclazole, triforine, validamycin, valifenalate, zoxamide, mandipropamid, flubeneteram, isopyrazam, sedaxane, benzovindiflupyr, pydiflumetofen, 3-difluoromethyl-1-methyl-1H-pyrazole-4-carboxylic acid (3′,4′,5′-trifluoro-biphenyl-2-yl)-amide, isoflucypram, isotianil, dipymetitrone, 6-ethyl-5,7-dioxo-pyrrolo[4,5][1,4]dithiino[1,2-c]isothiazole-3-carbonitrile, 2-(difluoromethyl)-N-[3-ethyl-1,1-dimethyl-indan-4-yl]pyridine-3-carboxamide, 4-(2,6-difluorophenyl)-6-methyl-5-phenyl-pyridazine-3-carbonitrile, (R)-3-(difluoromethyl)-1-methyl-N-[1,1,3-trimethylindan-4-yl]pyrazole-4-carboxamide, 4-(2-bromo-4-fluoro-phenyl)-N-(2-chloro-6-fluoro-phenyl)-2,5-dimethyl-pyrazol-3-amine, 4-(2-bromo-4-fluorophenyl)-N-(2-chloro-6-fluorophenyl)-1,3-dimethyl-1H-pyrazol-5-amine, fluindapyr, coumethoxystrobin (jiaxiangjunzhi), Ivbenmixianan, dichlobentiazox, mandestrob in, 3-(4,4-difluoro-3,4-dihydro-3,3-dimethylisoquinolin-1-yl)quinolone, 2-[2-fluoro-6-[(8-fluoro-2-methyl-3-quinolyl)oxy]phenyl]propan-2-ol, oxathiapiprolin, tert-butyl N-[6-[[[(1-methyltetrazol-5-yl)-phenyl-methylene]amino]oxymethyl]-2-pyridyl]carbamate, pyraziflumid, inpyrfluxam, trolprocarb, mefentrifluconazole, ipfentrifluconazole, 2-(difluoromethyl)-N-[(3R)-3-ethyl-1,1-dimethyl-indan-4-yl]pyridine-3-carboxamide, N′-(2,5-dimethyl-4-phenoxy-phenyl)-N-ethyl-N-methyl-formamidine, N′-[4-(4,5-dichlorothiazol-2-yl)oxy-2,5-dimethylphenyl]-N-ethyl-N-methyl-formamidine, [2-[3-[2-[1-[2-[3,5-bis(difluoromethyl)pyrazol-1-yl]acetyl]-4-piperidyl]thiazol-4-yl]-4,5-dihydroisoxazol-5-yl]-3-chloro-phenyl] methanesulfonate, but-3-ynyl N-[6-[[(Z)[(1-methyltetrazol-5-yl)-phenyl-methylene]amino]oxymethyl]-2-pyridyl]carbamate, methyl N-[[5-[4-(2,4-dimethylphenyl)triazol-2-yl]-2-methyl-phenyl]methyl]carbamate, 3-chloro-6-methyl-5-phenyl-4-(2,4,6-trifluorophenyl)pyridazine, pyridachlometyl, 3-(difluoromethyl)-1-methyl-N-[1,1,3-trimethylindan-4-yl]pyrazole-4-carboxamide, 1-[2-[[1-(4-chlorophenyl)pyrazol-3-yl]oxymethyl]-3-methyl-phenyl]-4-methyl-tetrazol-5-one, 1-methyl-4-[3-methyl-2-[[2-methyl-4-(3,4,5-trimethylpyrazol-1-yl)phenoxy]methyl]phenyl]tetrazol-5-one, aminopyrifen, ametoctradin, amisulbrom, penflufen, (Z,2E)-5-[1-(4-chlorophenyl)pyrazol-3-yl]oxy-2-methoxyimino-N,3-dimethyl-pent-3-enamide, florylpicoxamid, fenpicoxamid, metarylpicoxamid, tebufloquin, ipflufenoquin, quinofumelin, isofetamid, N-[2-[2,4-dichloro-phenoxy]phenyl]-3-(difluoromethyl)-1-methyl-pyrazole-4-carboxamide, N-[2-[2-chloro-4-(trifluoromethyl)phenoxy]phenyl]-3-(difluoromethyl)-1-methyl-pyrazole-4-carboxamide, benzothiostrobin, phenamacril, 5-amino-1,3,4-thiadiazole-2-thiol zinc salt (2:1), fluopyram, flufenoxadiazam, flutianil, fluopimomide, pyrapropoyne, picarbutrazox, 2-(difluoromethyl)-N-(3-ethyl-1,1-dimethyl-indan-4-yl)pyridine-3-carboxamide, 2-(difluoromethyl)-N-((3R)-1, 1, 3-trimethylindan-4-yl) pyridine-3-carboxamide, 4-[[6-[2-(2,4-difluorophenyl)-1,1-difluoro-2-hydroxy-3-(1,2,4-triazol-1-yl)propyl]-3-pyridyl]oxy]benzonitrile, metyltetraprole, 2-(difluoromethyl)-N-((3R)-1,1,3-trimethylindan-4-yl)pyridine-3-carboxamide, α-(1,1-dimethylethyl)-α-[4′-(trifluoromethoxy) [1,1′-biphenyl]-4-yl]-5-pyrimidinemethanol, fluoxapiprolin, enoxastrobin, 4-[[6-[2-(2,4-difluorophenyl)-1,1-difluoro-2-hydroxy-3-(1,2,4-triazol-1-yl)propyl]-3-pyridyl]oxy] benzonitrile, 4-[[6-[2-(2,4-difluorophenyl)-1,1-difluoro-2-hydroxy-3-(5-sulfanyl-1,2,4-triazol-1-yl)propyl]-3-pyridyl]oxy] benzonitrile, 4-[[6-[2-(2,4-difluorophenyl)-1,1-difluoro-2-hydroxy-3-(5-thioxo-4H-1,2,4-triazol-1-yl)propyl]-3-pyridyl]oxy]benzonitrile, trinexapac, coumoxystrobin, zhongshengmycin, thiodiazole copper, zinc thiazole, amectotractin, iprodione, seboctylamine, N′-[5-bromo-2-methyl-6-[(1S)-1-methyl-2-propoxy-ethoxy]-3-pyridyl]-N-ethyl-N-methyl-formamidine, N′-[5-bromo-2-methyl-6-[(1R)-1-methyl-2-propoxy-ethoxy]-3-pyridyl]-N-ethyl-N-methyl-formamidine, N′-[5-bromo-2-methyl-6-(1-methyl-2-propoxy-ethoxy)-3-pyridyl]-N-ethyl-N-methyl-formamidine, N′-[5-chloro-2-methyl-6-(1-methyl-2-propoxy-ethoxy)-3-pyridyl]-N-ethyl-N-methyl-formamidine, N′-[5-bromo-2-methyl-6-(1-methyl-2-propoxy-ethoxy)-3-pyridyl]-N-isopropyl-N-methyl-formamidine (these compounds may be prepared from the methods described in WO2015/155075); N′-[5-bromo-2-methyl-6-(2-propoxypropoxy)-3-pyridyl]-N-ethyl-N-methyl-formamidine (this compound may be prepared from the methods described in IPCOM000249876D); N-isopropyl-N′-[5-methoxy-2-methyl-4-(2,2,2-trifluoro-1-hydroxy-1-phenyl-ethyl)phenyl]-N-methyl-formamidine, N′-[4-(1-cyclopropyl-2,2,2-trifluoro-1-hydroxy-ethyl)-5-methoxy-2-methyl-phenyl]-N-isopropyl-N-methyl-formamidine (these compounds may be prepared from the methods described in WO2018/228896); N-ethyl-N′-[5-methoxy-2-methyl-4-[(2-trifluoromethyl)oxetan-2-yl]phenyl]-N-methyl-formamidine, N-ethyl-N′-[5-methoxy-2-methyl-4-[(2-trifluoromethyl)tetrahydrofuran-2-yl]phenyl]-N-methyl-formamidine (these compounds may be prepared from the methods described in WO2019/110427); N-[(1R)-1-benzyl-3-chloro-1-methyl-but-3-enyl]-8-fluoro-quinoline-3-carboxamide, N-[(1S)-1-benzyl-3-chloro-1-methyl-but-3-enyl]-8-fluoro-quinoline-3-carboxamide, N-[(1R)-1-benzyl-3,3,3-trifluoro-1-methyl-propyl]-8-fluoro-quinoline-3-carboxamide, N-[(1S)-1-benzyl-3,3,3-trifluoro-1-methyl-propyl]-8-fluoro-quinoline-3-carboxamide, N-[(1R)-1-benzyl-1,3-dimethyl-butyl]-7,8-difluoro-quinoline-3-carboxamide, N-[(1S)-1-benzyl-1,3-dimethyl-butyl]-7,8-difluoro-quinoline-3-carboxamide, 8-fluoro-N-[(1R)-1-[(3-fluorophenyl)methyl]-1,3-dimethyl-butyl]quinoline-3-carboxamide, 8-fluoro-N-[(1S)-1-[(3-fluorophenyl)methyl]-1,3-dimethyl-butyl]quinoline-3-carboxamide, N-[(1R)-1-benzyl-1,3-dimethyl-butyl]-8-fluoro-quinoline-3-carboxamide, N-[(1S)-1-benzyl-1,3-dimethyl-butyl]-8-fluoro-quinoline-3-carboxamide, N-((1R)-1-benzyl-3-chloro-1-methyl-but-3-enyl)-8-fluoro-quinoline-3-carboxamide, N-((1S)-1-benzyl-3-chloro-1-methyl-but-3-enyl)-8-fluoro-quinoline-3-carboxamide (these compounds may be prepared from the methods described in WO2017/153380); 1-(6,7-dimethylpyrazolo[1,5-a]pyridin-3-yl)-4,4,5-trifluoro-3,3-dimethyl-isoquinoline, 1-(6,7-dimethylpyrazolo[1,5-a]pyridin-3-yl)-4,4,6-trifluoro-3,3-dimethyl-isoquinoline, 4,4-difluoro-3,3-dimethyl-1-(6-methylpyrazolo[1,5-a]pyridin-3-yl)isoquinoline, 4,4-difluoro-3,3-dimethyl-1-(7-methylpyrazolo[1,5-a]pyridin-3-yl)isoquinoline, 1-(6-chloro-7-methyl-pyrazolo[1,5-a]pyridin-3-yl)-4,4-difluoro-3,3-dimethyl-isoquinoline (these compounds may be prepared from the methods described in WO2017/025510); 1-(4,5-dimethylbenzimidazol-1-yl)-4,4,5-trifluoro-3,3-dimethyl-isoquinoline, 1-(4,5-dimethylbenzimidazol-1-yl)-4,4-difluoro-3,3-dimethyl-isoquinoline, 6-chloro-4,4-difluoro-3,3-dimethyl-1-(4-methylbenzimidazol-1-yl)isoquinoline, 4,4-difluoro-1-(5-fluoro-4-methyl-benzimidazol-1-yl)-3,3-dimethyl-isoquinoline, 3-(4,4-difluoro-3,3-dimethyl-1-isoquinolyl)-7,8-dihydro-6H-cyclopenta[e]benzimidazole (these compounds may be prepared from the methods described in WO2016/156085); N-methoxy-N-[[4-[5-(trifluoromethyl)-1,2,4-oxadiazol-3-yl]phenyl]methyl]cyclopropanecarboxamide, N,2-dimethoxy-N-[[4-[5-(trifluoromethyl)-1,2,4-oxadiazol-3-yl]phenyl]methyl]propanamide, N-ethyl-2-methyl-N-[[4-[5-(trifluoromethyl)-1,2,4-oxadiazol-3-yl]phenyl]methyl]propanamide, 1-methoxy-3-methyl-1-[[4-[5-(trifluoromethyl)-1,2,4-oxadiazol-3-yl]phenyl]methyl]urea, 1,3-dimethoxy-1-[[4-[5-(trifluoromethyl)-1,2,4-oxadiazol-3-yl]phenyl]methyl]urea, 3-ethyl-1-methoxy-1-[[4-[5-(trifluoromethyl)-1,2,4-oxadiazol-3-yl]phenyl]methyl]urea, N-[[4-[5-(trifluoromethyl)-1,2,4-oxadiazol-3-yl]phenyl]methyl]propanamide, 4,4-dimethyl-2-[[4-[5-(trifluoromethyl)-1,2,4-oxadiazol-3-yl]phenyl]methyl]isoxazolidin-3-one, 5,5-dimethyl-2-[[4-[5-(trifluoromethyl)-1,2,4-oxadiazol-3-yl]phenyl]methyl]isoxazolidin-3-one, ethyl 1-[[4-[5-(trifluoromethyl)-1,2,4-oxadiazol-3-yl]phenyl]methyl]pyrazole-4-carboxylate, N,N-dimethyl-1-[[4-[5-(trifluoromethyl)-1,2,4-oxadiazol-3-yl]phenyl]methyl]-1,2,4-triazol-3-amine (these compounds may be prepared from the methods described in WO 2017/055473, WO 2017/055469, WO 2017/093348 and WO 2017/118689); 2-[6-(4-chlorophenoxy)-2-(trifluoromethyl)-3-pyridyl]-1-(1,2,4-triazol-1-yl)propan-2-ol (this compound may be prepared from the methods described in WO 2017/029179); 2-[6-(4-bromophenoxy)-2-(trifluoromethyl)-3-pyridyl]-1-(1,2,4-triazol-1-yl)propan-2-ol (this compound may be prepared from the methods described in WO 2017/029179); 3-[2-(1-chlorocyclopropyl)-3-(2-fluorophenyl)-2-hydroxy-propyl]imidazole-4-carbonitrile (this compound may be prepared from the methods described in WO 2016/156290); 3-[2-(1-chlorocyclopropyl)-3-(3-chloro-2-fluoro-phenyl)-2-hydroxy-propyl]imidazole-4-carbonitrile (this compound may be prepared from the methods described in WO 2016/156290); (4-phenoxyphenyl)methyl 2-amino-6-methyl-pyridine-3-carboxylate (this compound may be prepared from the methods described in WO 2014/006945); 2,6-Dimethyl-1H,5H-[1,4]dithiino[2,3-c:5,6-c′]dipyrrole-1,3,5,7(2H,6H)-tetrone (this compound may be prepared from the methods described in WO 2011/138281) N-methyl-4-[5-(trifluoromethyl)-1,2,4-oxadiazol-3-yl]benzenecarbothioamide; N-methyl-4-[5-(trifluoromethyl)-1,2,4-oxadiazol-3-yl]benzamide; (Z,2E)-5-[1-(2,4-dichlorophenyl)pyrazol-3-yl]oxy-2-methoxyimino-N,3-dimethyl-pent-3-enamide (this compound may be prepared from the methods described in WO 2018/153707); N′-(2-chloro-5-methyl-4-phenoxy-phenyl)-N-ethyl-N-methyl-formamidine; N′-[2-chloro-4-(2-fluorophenoxy)-5-methyl-phenyl]-N-ethyl-N-methyl-formamidine (this compound may be prepared from the methods described in WO 2016/202742); 2-(difluoromethyl)-N-[(3S)-3-ethyl-1,1-dimethyl-indan-4-yl]pyridine-3-carboxamide (this compound may be prepared from the methods described in WO 2014/095675); (5-methyl-2-pyridyl)[4-[5-(trifluoromethyl)-1,2,4-oxadiazol-3-yl]phenyl]methanone, (3-methylisoxazol-5-yl)-[4-[5-(trifluoromethyl)-1,2,4-oxadiazol-3-yl]phenyl]methanone (these compounds may be prepared from the methods described in WO 2017/220485); 2-oxo-N-propyl-2-[4-[5-(trifluoromethyl)-1,2,4-oxadiazol-3-yl]phenyl]acetamide (this compound may be prepared from the methods described in WO 2018/065414); ethyl 1-[[5-[5-(trifluoromethyl)-1,2,4-oxadiazol-3-yl]-2-thienyl]methyl]pyrazole-4-carboxylate (this compound may be prepared from the methods described in WO 2018/158365); 2,2-difluoro-N-methyl-2-[4-[5-(trifluoromethyl)-1,2,4-oxadiazol-3-yl]phenyl]acetamide, N-[(E)-methoxyiminomethyl]-4-[5-(trifluoromethyl)-1,2,4-oxadiazol-3-yl]benzamide, N—[(Z)-methoxyiminomethyl]-4-[5-(trifluoromethyl)-1,2,4-oxadiazol-3-yl]benzamide, N—[N-methoxy-C-methyl-carbonimidoyl]-4-[5-(trifluoromethyl)-1,2,4-oxadiazol-3-yl]benzamide (these compounds may be prepared from the methods described in WO 2018/202428).

The present invention will now be described with reference to the following examples, which are by way of illustration and do not limit the scope of the invention in any way. The following examples demonstrate the ability of 3-(difluoromethyl)-N-methoxy-1-methyl-N-[1-methyl-2-(2,4,6-trichloro-phenyl)ethyl]-1H-pyrazole-4-carboxamide (pydiflumetofen) to control or suppress the effect of phytopathogenic bacteria.

### BIOLOGICAL EXAMPLES

### Example 1—Effect of Pydiflumetofen on Xanthomonas perforans (Tomato Bacterial Spot)

The experiment was carried out in a greenhouse in the Olericulture Sector of the Federal University of Goiás. The location has temperature and humidity control. Tomato seedlings cv. Totalle with two true leaves were transplanted into 1 L pots containing professional growing media. Two days after transplanting, the first application of the substances was carried out. Bion (acibenzolar-S-methyl, 25 g product/ha—12.5 g ai/ha), Miravis (pydiflumetofen, 0.60 kg product/ha—120 g ai/ha), Kocide (copper hydroxide, 1.50 kg product/ha) and Kasumin (kasugamycin, 2 L product/ha) were evaluated. The untreated control received only water. For application, the pots were placed on the floor and spraying was carried out using a spray device (having 6 nozzles with 0.5 m spacing between nozzles) with a pressurized CO₂ sprayer and a spray volume of 300 L/ha.

The applications were carried out on days 1, 7 and 14. On day 9 (between the second and third applications), inoculation with a Xanthomonas perforans isolate was performed. The plants were uniformly sprayed once over all leaves with a suspension of the pathogen at a concentration of 107 colony forming units per millilitre (cfu/mL). Three evaluations were performed at 6, 13 and 18 days after inoculation (DAI), and the percentage of injured leaf (area of leaf with bacterial spot) area was calculated.

TABLE 1
Injured leaf area (%) observed at 6, 13 and 18 days after inoculation
(DAI) in tomato plants inoculated with Xanthomonas perforans.

| | Injured Leaf Area (%) | | |
|---|---|---|---|
| Treatment | 6 DAI | 13 DAI | 18 DAI |
| Control - Untreated | 2.95 | 9.19 | 16.86 |
| Bion ® - Acibenzolar-S-Methyl (25 g/ha) | 0.50 | 3.22 | 4.28 |
| Miravis ™ - Pydiflumetofen (0.6 kg/ha) | 0.92 | 3.45 | 4.02 |
| Kocide ® - Copper Hydroxide (1.5 kg/ha) | 2.06 | 7.06 | 12.09 |
| Kasumin ® - Kasugamycin (1 L/ha) | 2.33 | 5.27 | 10.69 |

The data in Table 1 shows that pydiflumetofen provides good control of Xanthomonas perforans up to 18 days after inoculation.

### Example 2: Comparison of SDHI Fungicides on Xanthomonas orycea/Rice/Preventative (Bacterial Blight of Rice)

3 week old rice plants cv. Balilla were treated with the formulated test compound in a spray chamber. Two days after application rice plants were infected by cutting the upper leaf level and the bacteria suspension applied on the cutting edges. After an incubation period of 14 days at 23° C. and 80% relative humidity, a visual assessment of the disease level was performed.

TABLE 2
Comparison of SDHI Fungicides on
Xanthomonas orycea / rice / preventative

| | Concentration | Efficacy |
|---|---|---|
| Substance | Mg ai/L | (%) |
| Isoflucypram | 60 | 0 |
| | 20 | 0 |
| | 6 | 0 |
| Boscalid | 60 | 0 |
| | 20 | 0 |
| | 6 | 0 |
| Pydiflumetofen | 60 | 99 |
| | 20 | 72 |
| | 6 | 13 |
| Fluxapyroxad | 60 | 0 |
| | 20 | 0 |
| | 6 | 0 |

The data in Table 2 shows that pydiflumetofen provides good control of Xanthomonas orycea at a range of 20 to 60 mg ai/L, and a marginal effect at 6 mg ai/L. Other SDHI fungicides tested did not provide either control or suppression of Xanthomonas orycea.

### Example 3: Effect of Pydiflumetofen on Xanthomonas campestris on Zinnia

Vegetatively mature zinnia plants were treated with pydiflumetofen treatments by foliar spray (for Xanthomonas or Pseudomonas spp.). One to two days post treatment, the plants were atomized with a bacterial suspension (1×108 cfu/mL, determined with a spectrometer) and maintained at 100% relative humidity for 24 to 48 hours to promote infection. The plants were then maintained in a greenhouse or outdoor shade structure and disease incidence and severity recorded, as well as plant health and fresh weight if applicable.

TABLE 3
Effect of Pydiflumetofen on Xanthomonas campestris on Zinnia

| | Rage | Rate | Number of | Application | Efficacy 12 |
|---|---|---|---|---|---|
| Substance | (g ai/100 L) | (floz/100 g ai) | Applications | Method | DAT* (%) |
| Control Uninoculated | — | — | — | — | — |
| Control Inoculated | — | — | — | — | — |
| Pydiflumetofen | 21.4 | 13.7 | 1 | Spray | 84 |
| Mural ® | 23.6 | 7.0 | 1 | Spray | 61 |
| (Azoxystrobin/ | | | | | |
| Benzovindiflupyr) | | | | | |
| Daconcil ® | 125.0 | 32.0 | 1 | Spray | 50 |
| (Chlorothalonil) | | | | | |
| Benzovindiflupyr | 55.2 | 2.3 | 1 | Spray | 63 |
| Actigard ® | 3.8 | 1.0 | 1 | Spray | 72 |
| (Acibenzolar-S-methyl) | | | | | |

*Days after treatment

The data in Table 3 shows that pydiflumetofen provides good control of Xanthomonas campestris.

### Example 4. Effect of Pydiflumetofen on Ralstonia spp. on Geranium

Vegetatively mature geranium plants were treated with pydiflumetofen treatments by drench (Ralstonia spp.). One to two days post treatment, the inoculum was applied as a soil-drench. The plants were then maintained in a greenhouse or outdoor shade structure and disease incidence and severity were recorded.

TABLE 4
Effect of Pydiflumetofen on Ralstonia spp. on Geranium

| | % Wilt 14 DAT | % Wilt 28 DAT |
|---|---|---|
| | (% efficacity vs. | (% efficacity vs. |
| | inoculated check) | inoculated check) |
| Control Uninoculated | 0 | 0 |
| Control Inoculated | 23.0 | 62.5 |
| Pydiflumetofen (15.6 g ai /100 L) | 3.5 (84) | 18 (87) |
| Cease ® (Bacillus subtilis)^{a} | 12.5 | 42.0 |

^{a}Cease ® is an organic biofungicide comprising Bacillus subtilis as the active ingredient

The data in Table 4 shows that pydiflumetofen provides control or suppression of Ralstonia spp.

1. A method of controlling or suppressing phytopathogenic bacteria on useful plants, said method comprising applying an effective amount of 3-(difluoromethyl)-N-methoxy-1-methyl-N-[1-methyl-2-(2,4,6-trichloro-phenyl)ethyl]-1H-pyrazole-4-carboxamide, to the plant, plant part, or locus thereof.

2. A method according to claim 1, comprising applying an effective amount of a composition comprising 3-(difluoromethyl)-N-methoxy-1-methyl-N-[1-methyl-2-(2,4,6-trichloro-phenyl)ethyl]-1H-pyrazole-4-carboxamide to the plant, plant part, or locus thereof.

3. The method according to claim 1, wherein the phytopathogenic bacteria is selected from Agrobacterium spp., Candidatus liberibacter spp., Clavibacter spp., Dickeya spp., Erwinia spp., Pectobacterium spp., Pseudomonas spp., Ralstonia spp., or Xanthomonas spp.

4. The method according to claim 1, wherein the phytopathogenic bacteria is Agrobacterium spp., Pseudomonas spp., Ralstonia spp., or Xanthomonas spp.

5. The method according to claim 1, wherein the phytopathogenic bacteria is Xanthomonas campestris, Xanthomonas orycea, or Xanthomonas perforans.

6. The method according to claim 1, wherein the useful plant is tomato, geranium, pelargonium, magnolia, rice, or zinnia.

7. The method according to claim 1, wherein 3-(difluoromethyl)-N-methoxy-1-methyl-N-[1-methyl-2-(2,4,6-trichloro-phenyl)ethyl]-1H-pyrazole-4-carboxamide is applied to the plant, plant part, or locus thereof in an amount from 20 g per hectare to 600 g per hectare.

8. Use of 3-(difluoromethyl)-N-methoxy-1-methyl-N-[1-methyl-2-(2,4,6-trichloro-phenyl)ethyl]-1H-pyrazole-4-carboxamide, or an agrochemically acceptable salt, isomer, stereoisomer, diastereoisomer, enantiomer or tautomer thereof, to control or suppress phytopathogenic bacteria on useful plants.
